(19) United States
(12) Patent Application Publication
(10) Pub. No.: US 2013/0110674 A1
(43) Pub. Date: May 2, 2013

(54) SYSTEM AND METHOD FOR PROVIDING ADVANCED MERCHANT SELF-ENABLED MERCHANDISING BASED ON VARIOUS DATA

(71) Applicant: Roland Schoettle, Freeport GBI (BS)

(72) Inventor: Roland Schoettle, Freeport GBI (BS)

(21) Appl. No.: 13/590,623

(22) Filed: Aug. 21, 2012

Related U.S. Application Data
(60) Provisional application No. 61/527,448, filed on Aug. 25, 2011.

(51) Int. Cl. G06Q 30/06

(52) U.S. Cl. CPC G06Q 30/0609; G06Q 10/067
USPC 705/26.35; 705/348

(57) ABSTRACT

In one embodiment, the merchant is free to choose the correct sales/marketing method or methods for their products and services and may choose to experiment with different methods and combinations of methods to determine what is best for their business. For example, merchants can focus on product quality, customer service and maximizing profitability and almost anything else that relates to their business without being concerned about whether they have locked themselves into the wrong sales and/or marketing model(s). The same is true for customers. Using the embodiment described herein, a customer (or potential customer) could choose which model they prefer instead of having to go elsewhere (to another merchant) for any preferred model (thereby providing additional analytics and information that can be used comparatively with a high degree of accuracy and repeatability using site standardized metrics).

### CROSS-REFERENCE TO RELATED APPLICATIONS

The present application claims priority to co-pending U.S. Provisional Patent Application No. 61/527,448, entitled “SYSTEM AND METHOD FOR PROVIDING ADVANCED MERCHANT SELF-ENABLED MERCHANDISING BASED ON VARIOUS DATE”, filed Aug. 25, 2011, and is related to commonly owned U.S. patent application Ser. No. 12/488,320 filed on Jun. 19, 2009, entitled, “SYSTEM AND METHOD FOR ProvidING INFORMATION ON SELECTED TOPICS TO INTERESTED USERS”; and U.S. patent application Ser. No. 12/488,336 filed on Jun. 19, 2009, entitled, “SYSTEM AND METHOD FOR AUTOMATICALLY RESTRUCTURING DATABASE ENTRIES BASED ON DATA OBTAINED AMONG A PLURALITY OF USERS”; which applications are hereby incorporated by reference herein.

### TECHNICAL FIELD

This disclosure is directed to electronic commerce systems and more particularly to a system and method for economic development, online marketing and ongoing improvement of any merchant, local, regional, national or international economy.

### BACKGROUND OF THE INVENTION

Currently, it is not possible for a merchant to test, compare and/or use different sales and/or marketing models in actual commerce that might better fit the merchant's business. The mechanisms that do exist for running business models are designed in a manner that once a merchant selects a marketing model it is difficult, and expensive to change. The problem is compounded in that there also does not exist a system to simultaneously test and run numerous different sales and/or marketing models using different parameters. These parameters could be, for example, different types of events, different products, different times or schedules, different demographics, different quoting processes, different sales and marketing processes.

### BRIEF SUMMARY OF THE INVENTION

There are disclosed systems and methods which provide for a plurality of merchant-enabled sales/marketing models that are integral to maximizing a merchant's business model.

In one embodiment, the merchant is free to choose the correct sales/marketing method or methods for their products and services and may choose to experiment with different methods and combinations of methods to determine what is best for their business. For example, merchants can focus on product quality, customer service and maximizing profitability and almost anything else that relates to their business without being concerned about whether they have locked themselves into the wrong sales and/or marketing model(s). The same is true for customers. Using the embodiment described herein, a customer (or potential customer) could choose which model they prefer instead of having to go elsewhere (to another merchant) for any preferred model (thereby providing additional analytics and information that can be used comparatively with a high degree of accuracy and repeatability using site standardized metrics). The benefit is that the user and merchant can each choose the sales/marketing mechanisms they are most comfortable with and are not constrained by traditional sales/marketing practices—they can develop entirely new opportunities to better engage with each other because they aren't pushed to go elsewhere.

In another embodiment, the circumstance under which the merchant can request and/or enable any number of deals is highly customizable to any requirement set by the merchant and/or the proposed recipient (customer or potential customer, including time-based (for example, a deal can run seasonally, monthly, daily, hourly, only on Tuesdays, etc.), finance-based (e.g., only on paydays, etc.), geography-based (e.g., only within the region, only within “x” miles of a merchant location), product or service type (e.g., summer and winter clothes are sold simultaneously but only in those worldwide regions where the seasons correspond with the product), customer relationships and demographics (is the merchant under new ownership, are the potential customers newly married, young, old, divorced, long standing or new customers) and so on. The system can mix and match any number of these customizations or none at all, depending on the merchant's own requirements.

In another embodiment, the merchants who use the system have the ability to set any and all deal terms, including but not limited to discount amounts/percentages, listing fees/percentages, quantities on deal offers, time limits, deal schedules (e.g., don't run my deal at the same time and place as my competitors), numbers of items that can be sold to any one person, entity types (e.g., individuals or business buyers, how many can be sold as gifts and to whom).

Another embodiment is to run one, single instance of the system for many merchants and users (but securely partition each merchant and users data) represented by a single seamless interface. In another embodiment, the system could be set and managed by any number of individual merchants (and end-use potential and actual customers) to enable and deliver multiple sales/marketing mechanisms specific to themselves including: Group Buying (e.g., Groupon, Living Social), Catalog purchasing (online shopping carts); Local purchasing (vouchers); Point of Sale purchasing (customer present transactions); Loyalty purchasing (coupons for regular customers); Hyper-local or instant sales, B2B sales; Predictive Sales; Penny Auctions; Regular Auctions; Classified listings; Multi-level sales; Direct sales (Targeted sales); Warehouse Direct; Manufacturer Direct; whether member based or not (e.g., bulk buying clubs).

In another embodiment, the system can also open new markets for existing products by allowing the merchant to target different demographics, geographic regions, and other factors most comfortable to the intended audience. In other words, a merchant using the proposed system could offer entirely new business models for different customer types simultaneously while also adapting to changes in customer behavior, all in real-time, if desired. For example, products may be targeted at customers who enjoy the thrill of an auction and can be re-targeted at customers who would only be interested in a more conservative catalog purchasing model.

In another embodiment, the system can also provide and encourage changeable deal flows, purchase flows, sales processes, marketing processes, and mechanisms. Being able to offer multiple deal mechanisms in one spot can open new sales channels.

Another benefit of this system is that it allows the merchant to try “fad” sales mechanisms with little risk to their business. For example, penny auctions are very popular today, but maybe less effective in the future. Merchants can use the fad to increase sales while that sales mechanism is in favor.

The system can be very simple or very sophisticated. It can also be set to provide two or more sales/marketing models where each model itself can be very simple or very sophisticated. The system can provide for comparison testing and analytics of any and all sales/marketing models. In all cases the models can be fixed and/or limited or extensible and modular. The models can focus only on one specific function or benefit or a combination of numerous functions and benefits. Where numerous functions and benefits are desired, the models can be used to address all aspects that can affect sales or marketing (the business itself), including but limited to any combination of: cost structures; pricing structures, display/cataloging structures, finance; inventory; banking; credit; risk; logistics; accounting; strategic planning; tactical execution; customer service; customer satisfaction; customer/employee acquisition; customer/employee attrition; demographics; associations and groups; highly targeted (e.g., detail-specific) and/or bulk broadcast methods; geographic locations; analytics; scheduling; time management; relationship management; asset management (including virtual assets); and resource planning.

In another embodiment, the system can also be used to structure entirely new sales/marketing models. It can mix and match elements from any sales/marketing models to create new sales/marketing models at low cost and low risk. In another embodiment, this ability is user definable. In another embodiment, new elements can be created and old ones updated to meet specific requirements. Elements can be static or dynamic. Elements can also encompass linear and non-linear methods and processes using software building blocks which have a common system and method of “interfacing” and interlocking with each other.

In another embodiment, the system can also provide for any number of merchants and/or customers to be part of any number of buying alliances for any number of manufacturers, products, models, services, etc, with or without being part of a formally recognized group. In other words, a single merchant or person could be part of a group that brings to bear the buying power of a giant company without exposing themselves to that company or to any other potential competitor. In such a situation, the system and method described here would keep them anonymous if desired by the merchant. Of course the merchant or customer could also opt to announce their alliance or “membership” if they so choose. The benefit to this sales/marketing method and system is extremely difficult for a small/medium-sized merchant to afford or achieve on their own.

In another embodiment, the system can also provide for any number of individual merchants and customers to be part of a banking system—e.g., one that aggregates merchants and customers under a “master” account, but where each merchant and customer has their own account. The system and method described here would use the aggregated financial power of any grouping to provide the best financial terms (e.g., volume discounts on credit card transaction); minimize fraud and chargebacks (customers known to commit fraud would be blacklisted and the list distributed to all merchants in the group); allow the transfer of money from business to business in near real-time and without the expense and hassle of large-scale payment logistics (long receivables and/or payables), from consumer to business, from business to consumer and from consumer to consumer at drastically discounted rates. These are primarily “ledger-management” transactions under the master account and therefore able to be performed in real-time outside the transaction flow of the banks that house the master accounts. The system includes the ability to include currency exchange at the best rate for even the smallest customers. In effect the “master” account acts as a hybrid proxy bank for its customers and merchants and gives everyone financial capabilities they could otherwise not afford. Because the sales/marketing model system and method described herein can have everyone run on the same “rails” to perform anyone-to-anyone transactions electronically, significant discounts (e.g., averaging in one example ˜5.2%) are realizable as compared to credit cards.

Another advantage is that all of the benefits can also be provided under one worldwide system and method acceptable to all merchants and customers with little to no risk. We call this feature pluriPay for our system and can be a physical card or a virtual account. The sales/marketing model can, for example, include a “card” that can be represented to everyone using the system and method as a discount card, loyalty card, gift card, pre-loaded credit or money card (where users use the credit in their own accounts as backing) and a traditional credit card such as Visa or Mastercard (when partnered with these companies). When represented as a money card, the system and method can minimize cash fraud/theft (in many regions of the world, including the Caribbean, employee cash “skimming” is rampant). The pluraPay card, in one embodiment, is a membership-based card and payment system that enables a new community of deal seekers that stay loyal to the club. In this manner, the issuer of the card has the right to mass market buyers and merchants together. One goal is to create a new hybrid merchant banking system that includes a closed loop banking component for merchants and their customers and where the system also offers the best rates on traditional open loop credit/debit (Visa, MasterCard, AMEX, etc.) facilities.

In another embodiment, the system can also reduce logistics and shipping costs (e.g., by aggregating fulfillment and delivery costs) under new sales/marketing models.

In another embodiment, the system can also publish merchant inventory, either individually or as part of a group or groups, with or without prices (and other details), to any number or groups of customers and potential buyers under a new sales/marketing system so as to encourage local purchases—where merchandise is stocked locally. Such a sales/marketing system is more environmentally friendly than having the same product shipped again from far away and therefore possible to be included in “green” initiatives, including the possibility of receiving environment-related credits (e.g., carbon-offsets).

In another embodiment, merchants can also quickly use and deploy various standardized e-commerce “shopping carts” under a new sales/marketing model. Standardized presentment of shopping cart functions would help to legitimize and accelerate a merchant's presence online (e.g., customers become familiar and comfortable with what appears to be a standard).

In another embodiment, merchants can also quickly use and deploy various standardized real-world “point-of-sale” services under a new sales/marketing model. Standardized presentment of point-of-sale functions would help merchants train and deploy staff Staff trained at any merchant would be easier employed at any other merchant because they would require little, if any, new point-of-sale training.

In another embodiment, manufacturers, merchants and users can also standardize on product/service descriptions, images, videos, codes and barcodes (e.g., common libraries) that can quickly enable merchants to create sales and sales/marketing mechanisms (of highest quality using the least time and effort). Where desirable merchants and users can also create their own descriptions, images, videos, codes, barcodes and feedback that cross-reference to those of the manufacturer. These can be set as open (public) to all users of the system or unique (private) to any merchants or users (and include permissions such as the ability to modify).

In another embodiment, the system can standardize the input, updating, editing and/or display of products that have differing “features” like sizes, colors, styles but that are otherwise from the same product family and/or model numbers. This can provide the ability to easily search for and cross reference products from different manufacturers and merchants based on similar features that otherwise are difficult to cross reference or index. For example, a customer looking for a specific size of red sweat shirt can instantly browse all merchants and manufacturers and still be assured that all products presented meet the same size and color requirements. This also allows less savvy users to input more products into the system while meeting system standards feature descriptions and allows for more useful product/service feedback from users.

In another embodiment, the system can standardize the input, updating, editing and/or display of products based in whole or in part on their “ingredients” or lack of ingredients. This can provide the ability to easily search for and cross reference products from different manufacturers and merchants based on ingredients that otherwise are difficult to cross reference or index. For example, a customer wanting to review inventory from all the merchants/manufacturers in the system can select foods/supplements without gluten and/or that are organic and/or that are vegetarian. This also allows less savvy users to input more products into the system while meeting system standard ingredient descriptions and allows for more useful product/service feedback from users (including but not limited to product/service effectiveness, primary and side effects).

In another embodiment, the system provides a standardized method for fitting images to any product display (e.g., standardized tools that allow for scaled cropping, aspect ratio cropping, color management, best image compression, etc) so as to maintain high quality presentations at low bandwidth and file sizes.

In another embodiment, merchants can also use a standardized method of accounting (e.g., chart of accounts entries (numbered or named accounts)) that can be universal to all merchants under a new sales/marketing model so as to make merchant to merchant (B2B) transactions much less prone to entry errors and easier to audit by third parties. Where desirable, merchants can cross-reference their legacy systems to those of the new sales/marketing model described herein. The benefit of having a standardized chart of accounts would also make it easier to find and likely less costly to hire bookkeepers and accountants. A standardized system would also dramatically reduce training costs. Finally, a standardized bookkeeping/accounting system would make it easier for entrepreneurs to start and run successful new businesses.

In another embodiment, any number of merchants and/or individuals can also be assembled into any number of groups, whether invisible or visible and/or private or public to other merchants and/or individuals under a new sales/marketing model. Where appropriate, these groups, merchants, and/or individuals can be published under a “yellow-pages” type directory that make it easier for general and specific merchants to be found by general and specific customers.

In another embodiment, any number of merchants, customers, and potential buyers can also pick and choose when to run sales/marketing events that minimize overlap or conflict with other events that might compete with their event.

In another embodiment, any number of merchants, customers, and potential buyers can also schedule when to run sales/marketing events. If, for example, two or more merchants want to have their sales/marketing events run at the same time in the same city, but don't want to compete (assuming their products are similar), the system would automatically manage event scheduling (e.g., first create an auction for that time/region slot and then schedule the loser into the next appropriate unused slot). In another embodiment, the system would integrate automatically with common email, calendar, PIM and CRM clients (e.g., Microsoft Outlook, Apples' Mail and iCal, Google mail, etc.) and/or any other system that can be extended so as to keep track of an individual's time and event functions, should they wish to do so.

In another embodiment, the system can also quickly sell stock for merchants with inventory about to spoil or otherwise is about to become stale dated. (E.g., a merchant that has juice or milk that is about to go past its “sell by” date can immediately implement a new sales/marketing model that reduces or eliminates this inventory. The model could include, but is not limited to, selling at any discount desired by the merchant (or customer) or giving to the poor, homeless or other charity as a tax write-down).

In another embodiment, the system can also include the management of any and all relationships between customers, merchants and all users—including the ability to show all linkages and degrees of separation between connections.

In another embodiment, the system can also gather data from external devices and data sources so as to determine a sales/marketing model based on the type and/or location and/or distribution and/or demographics and/or weather and/or time of day/week/month/year. For example, the system could gather data from local “home” weather stations and from tide tables to deliver a sales/marketing model for merchants that are focused on sailors as customers within a specific locale. Another example: the system could gather data from local weather stations and local cameras and local individuals to show traffic patterns during bad weather (with visual confirmation on cell phones, for example) or to show where police have set speed traps.

In another embodiment, the system can deliver sales/marketing models based on the user device (e.g., smart phone users only).

In another embodiment, the system can gather information from local events to help local restaurants target sales/marketing events based on the timing and/or type and/or expected turnout of the event.

In another embodiment, the system can also include the management of any and all user profiles, including the ability to create an “inventory” of user likes, dislikes, wants, favorites, etc. In another embodiment, merchants and/or customers can also be part of any number of communications systems/channels. For example, the system can instantly connect merchants with customers who are purchasing under a specific sales/marketing model (ultra-elite products or customer who have purchased under a specific sales/marketing model that requires hand-holding or support functions to enable/finalize the sale or customers that have purchased under a subscription model where the sales/marketing model can determine and help circumvent a lag in usage).

In another embodiment, the system can also be used to enable numerous local services that direct users to local merchants. Although this can be structured as a standard advertising platform (typically where the local merchant is the advertiser), it can also be structured as a community service for members of a sales/marketing model.

In another embodiment, the system and method can also be used to encourage low-cost cross-pollination (e.g., where non-competitive ads are bartered or shared amongst all merchants in the system) of online advertising that is better targeted and lower cost than is available from search engines.

In another embodiment, the system can also provide a full featured API so as to encourage additional software development which would further the “mash-up” of new sales/marketing models (e.g., software plug-ins/modules and applications) via an “apps” store.

In another embodiment, merchants can also use industry standardized authorization and security processes under any and all new sales/marketing models.

In another embodiment, the features and benefits can also be delivered over numerous different sites that may each be specific to any merchant type, customer type, product type and/or where the sites are designed to be simplified portals to various functions of the sales and/or marketing models but where these numerous different sites use common backend systems. In another embodiment, all of these sites and systems can use a common application authentication and authorization authority thereby allowing for multi-domain authorization of applications (single sign-on authority for Apps, subsystems, and users).

In another embodiment, the system can also include tools to help the merchant maximize their return for any sale/marketing campaign or model they offer. Such tools can include Return on Investment and Risk Management calculators.

In another embodiment, the system can also include the ability to use on-the-ground salespeople to sell and market product and services from any or all merchants and any or all of their products. (e.g., a sort of Amway for the entire system where any merchant can have their products and services included). In another embodiment, the merchant wanting on-the-ground sales can set any and all distribution parameters, including but not limited to geographic, demographic, and timing constraints.

In another embodiment, the system would also use an open, compliance-based infrastructure (e.g., XML, DocBook, SGML, EbXML) that enables the global use of electronic information in an interoperable, secure, and consistent manner by any and all merchants and users.

In another embodiment, the system can also include any or all of the previously mentioned embodiments.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a system including the concepts of the present invention;

FIG. 2 shows one embodiment of a flow chart showing the login and registration processes of the system for a user;

FIG. 3 shows one embodiment of a flow chart showing the login and registration processes of the system for a merchant/business;

FIG. 4 shows one embodiment of a flow chart showing how a product (product data) is input into the system;

FIG. 5 shows one embodiment of a flow chart showing how a sales model is input into the system;

FIG. 6 shows one embodiment of a flow chart showing how a deal is input and provisioned into the system; and

FIG. 7 shows one embodiment of a flow chart showing how a commerce subsystem may interact between users and buyers within the system.

### DETAILED DESCRIPTION OF THE INVENTION

### Sales/Marketing Model Testing/Deployment

As used herein, the definition of a merchant is anyone who can enable a transaction. This means that anyone who wants to sell something is a merchant even if they do not have a commercial structure and traditional commercial bank account from which to do it (the standard banking definition of merchant) or don't have a formal business license. An example is anyone who uses eBay or Craigslist to sell something. Another example is anyone from outside the U.S. and Canada that works in the U.S./Canada and that sends money back home (e.g., via Western Union). However, for the preferred embodiment, a user that is enabling a transaction must declare themselves a merchant within the system.

It is also important to define the differences between a sales/marketing model or deal and a sales event. A sales model, as used herein, is the framework (set of rules) for specific types of sales, and would include, for example, geographic location, demographics, pricing, timing, etc. On the other hand, a sales event uses a specific sales model to implement a particular sales transaction. Typically, sales models sales/marketing mechanisms are used to enhance normal sales and are made special for a specific occasion using sales/marketing models that differ from the normal sales/marketing model. For example, offering toasters at a 50% discount from normal retail for anyone clicking on a web site between three and three-ten in Pittsburgh, would be a sales model. Someone clicking on the web site during that time period from a Pittsburgh location would complete a sales event.

More recently, sales events (regardless of what they may be) are proving too mundane and increasingly ineffective at attracting new customers and profits to the merchant. Merchants, like any other businesses, are looking for new sales and marketing models (systems and methods) that work better than what they have now and that can be “hyper” versions of a traditional sale model. These hyper versions are sometimes called “deals” and are designed to differentiate themselves from standard business and typical sales models. Deals are typically limited in some functional way that makes them more desirable. Often, the deals have limitations based on tight time frames or limited quantities in exchange for deeper discounts and immediate cash flow. Note that within the general vernacular of the merchant industry, “sales events” and “deals” are often used interchangeably although for the purpose of this discussion, deals are thought to be more effective than sales events.

For example, group buying that has a specific time frame within which a certain number of sales must occur is a sales/marketing model that can deliver a hyper sales “deal”. Merchants use various sales/marketing models from which to create various sales events/deals.

Traditionally, merchants use “sale” events for the purpose of quickly increasing sales and/or revenues (maximizing the transfer of funds from buyer to seller) and or market/awareness. For all but the largest merchants this requires a sales/marketing model that is not in standard use by the merchant (otherwise it wouldn't be a sale). Further, where businesses are subject to fast-paced changes in consumers' spending habits and demographics and/or fast technological advancements, it increasingly becomes impossible for any merchant to know which sales/marketing models work well or best for their products and services and increasingly impossible to afford a single sales/marketing model change, despite the fact that more than one sales/marketing model may be required simultaneously to maximize the merchant's business without adding too much risk. Currently no such system or method exists.

Merchants may want to test or deploy multiple different sales and marketing models so as to maximize their business and minimize their risk including but not limited to: specific sale/deal events to specified or unspecified groups; catalog purchasing; local purchases (people within geographic proximity so as to provide hands-on service and support or to avoid shipping of odd/oversize items); vouchers whether to specified or unspecified audiences; point of sale or customer-present transactions; non-standard auctions (e.g., “penny” auctions); multi-level sales/marketing; direct to target sales; discount/warehouse direct transactions; manufacturer direct; product or model specific; membership-based clubs; business to business; predictive sales (intelligently predicting what a customer wants or needs); customer pays before merchant ordering discounts; and so forth.

While the system and method described herein is beneficial for Return On Investment (ROI) assessment and management, there is a very clear benefit to risk management that may be of equal or higher importance. It should be clear that Return On Investment and Risk Management are highly related but different. In many cases, Risk Management is much more important and much more beneficial to the business than ROI because Risk Management, performed correctly, sets the stage for maximizing ROI. The system and method described here minimizes what would otherwise be an extremely high risk business maneuver. In fact, in most cases any significant changes to the sales/marketing (business) model fall under the “make or break” category of business decisions.

Currently, there are no sites or services that offer multiple sales mechanisms in a single site/service or user-interface and none that include any comparison analytics directly related to the sales/marketing model. The most common approach today is to use Google Analytics which is vastly insufficient (near useless) for the required purpose. Deals are made currently by offloading the delivery of a different sales/marketing model to a company with its own single sales/marketing model. For example, offloading discounting of the toaster to a company such as Groupon which operates under its own terms and conditions. In fact, most if not all, online-businesses centralize all their business practices on a single sales mechanism. For example, the deal site Groupon focuses on group buying and discount selling to its “members”. Craigslist concerns itself with classified advertising. In both these cases, the sales mechanism employed by the offloaded company is the business of the other company and thus all “deals” must be in keeping with their rules and regulations.

The typical, although primitive, approach to running a merchant promotion (sales deal) is to use one or more of: the television, radio and/or newspaper advertising models; the online advertising model (e.g., banners); the online and local classifieds model; the subscription model (Amazon merchants) and specialty sites (e.g., AutoTrader.com for cars). Most, if not all, of these deal sites carry an upfront cost with no guarantee of success.

Another approach is to post items on auction sites where the site takes payment from the merchant as a percentage of the purchase price. In summary, a merchant uses the auction sites sales/marketing model for their own purposes, but under the auction sites terms and conditions. Although the merchant can usually post to this type of service, there is no ability for the merchant to set their own terms; no ability to structure a hard hitting direct deal to known potential customers; no ability to maximize the schedule on which to run their deal (avoid running deals at the same time as competitors); no ability to avoid selling too many items to any specific user (e.g., to competitors, to friends and family, as gifts, whitelists, blacklists, etc.) and most importantly, no ability to guarantee a timely sale at a reasonable and sustainable margin. (eBay for example has very many items that do not sell at all, very many items that do not sell at a sustainable profit, and very many items that must wait for “sucker” buyers from unethical merchants). Merchants that find themselves too poor to use other sales/marketing models can often be found on these sites. They need easy, affordable, low risk access to new sales/marketing models as described herein to grow their businesses.

Concurrently, another difference sometimes used to differentiate between certain sales/marketing models is where items are promoted to potential consumers using third-party marketing systems such as television, radio, newspaper, and online advertising where buyers are unknown, mass marketed and have not opted-in, vs. newer sales/marketing models which typically send specifically defined advertising to specific (known) buyers, for example, under an opt-in membership sales/marketing model such as the one using profiling as described in the above-identified patent applications. Methods directed at the general public present a significant drawback since the merchant cannot send useful information directly to specifically known potential buyers without violating privacy laws. In other words, if a business wanted to test various sales/marketing models and compare their result (e.g., ROI, or close rate, or type of financing/banking) they cannot currently do so, except by using the systems and methods discussed herein.

The present invention allows a merchant to select or test for the best sales/marketing approach for any specific or non-specific event or time before setting their business sales/marketing course. They can select or test (compare) among vastly differing sales/marketing models such as prepaid vs. direct vs. subscription vs. direct plus maintenance and so forth. In addition, using the systems and methods of this invention, a merchant can select or test among various financing arrangements, instead of relying on anecdotal, consultant-driven, or seat-of-the-pants sales and marketing models, a merchant can actually test the real market places setting its own rules for the test. The system described here can be used in the real world for real commerce by real people for provable real-world results.

### Merchant Self Enablement of any and all Sales/Marketing Models

The systems and methods of this invention allow merchants to determine all relevant terms and conditions for its own benefit and/or self-enable one or more sales and/or marketing models from a variety of sales/marketing models.

For example, all online deal sites such as Groupon and Living Social use a merchant-delivered deals sales/marketing model. Thus, they do not offer the service or product themselves, but provide a select sales/marketing platform focused singularly on “group” discounts offered by local merchants. All similar deal sites set the conditions and terms to display deals on their sites and only post deals on their sites themselves, ostensibly on behalf of the merchant. Each site “vets” the deals they want to run, including setting deal terms, quantities, margins, when to run and so forth because their focus is not on maximizing the benefit for the merchant, but rather ensuring the best terms and conditions for themselves. These sites take a significant portion of the revenue from each merchant deal for themselves and only work with those merchants that generate the highest revenues for themselves.

These sites are self-centric rather than merchant-centric. As such, there are many occurrences where merchants who agree to the deal sites' terms and conditions are locked into merchant deals that are detrimental to the merchant, sometimes catastrophically, sometimes even leading directly to bankruptcy of the merchant.

An obvious drawback for the merchant is that deal sites do not include proper tools to help the merchant maximize their return for any deal they offer. A decent ROI is assumed and promoted to the merchant by the deal site (whether it exists or not). If for any reason the deal site rejects the merchants deal (e.g., because the deal site wants more), the merchant may find itself without another place to go for a viable sales/marketing. Should the merchant create sufficient interest at the next deal service, it will again be at the mercy of the margins and terms and conditions of that service. Bottom line is that the merchant is always in an unfavorable position. Either the merchant runs the deal at a significant, sometimes deadly, discount or it does not run the deal. In any case, the merchant is unable to easily and affordably enable and compare any new sales/marketing plan that meets its own business terms and conditions.

Worse yet is that many deal sites contractually obligate the merchant who signs-up to run a deal to a long exclusive period, a period where the merchant cannot try another competitive site or service. When a merchant agrees to the terms and conditions of a deal service (e.g., to run their first deal), they are contractually constrained from seeking better terms from all similar sites for a period typically set between 6 and 12 months. If the initial deal is honestly deemed unsuccessful by the merchant (very many are deemed as failures by merchants), the merchant may literally be left with NO options.

The merchant that cannot interest a deal site or that is locked into an untenable long term constraint or that cannot undertake the technical challenge or cannot afford the cost or cannot afford the risk is therefore unable to promote new sales/marketing models for their business. In such cases, the merchant cannot leverage the low cost marketing power of the Internet and becomes significantly less competitive vs. those that can. By allowing each merchant to tailor its own deal and by only requiring the merchant to abide by a few “house” rules, a merchant is free of the restraints of previous deal sites.

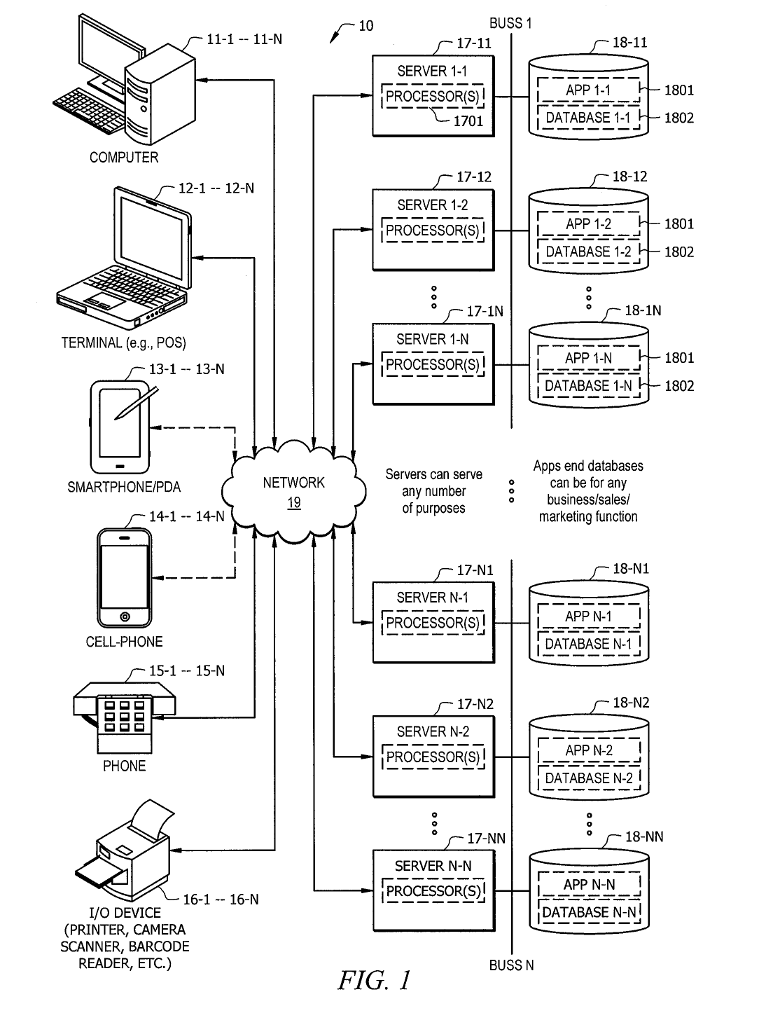

FIG. 1 shows one embodiment 10 of a system including the concepts of the present invention. In this embodiment, users interface with the system using a variety of devices such as computers 11-1 to 11-N, terminals 12-1 to 12-N (e.g., point-of-sale terminals), smart-phones, personal digital assistants 13-1 to 13-N, cell phones 14-1 to 14-N, regular phones 15-1 to 15-N, and various I/O devices (e.g., bar code readers, cameras, scanners, printers) 16-1 to 16-N, but any type of device having communication capability can be used. The communication is preferably wireless using the traditional telephone voice network and/or Wi-Fi and/or WiMAX but the network can be combined with any signaling network or with any data network either in combination or any one of which can be used by itself. In addition, each communication can use the type of network available at the time of usage, or most suitable of the type of communication from time to time. Note also that some communications can be to devices that are not traditionally thought of as communication devices but which have communication capability. An example of this could be a car or boat or residential weather station for which information can be made available to and/or from the device from time to time.

As will be detailed hereinafter, users at devices 11-1 to 16-N communicate with one or more servers 17-11 to 17-1N and/or 17-N1 to 17-NN via one or more networks 19. The networks can be traditional telecommunications networks, cellular networks, or any wired or wireless networks, the Internet or a combination thereof. The servers are controlled by one or more processors 1701 which interface with one or more applications 1801 and/or one or more databases 1802. The applications and databases are shown installed together on machines 18-11 to 18-NN but could be installed separately or in any combination on any number of accepting machines. The databases and applications can be internal to the server or external thereto and can be at the same time operating on many machines whether in the same physical location or different physical locations. In some situations, the applications and/or databases that are accessed from a first server are actually part of another server and can be local or remote to any server.

In operation, a user at a device, such as device 11-1, can set and edit user and merchant profiles, browse for products/services, buy products/services, input/edit products/services, sell products/services, and can input, edit, request, use, and analyze (test) various sales and/or marketing models via one or more inputs, such as keypad and can view information on display all of which is controlled by processor.

Although the system could be set to allow any user to set and/or edit a sales and/or marketing model, in one embodiment (the one described herein) only users that are logged-on and known to the system as merchants are eligible to set/edit sales and/or marketing models.

Additionally, in one embodiment the system uses applications (apps) to determine and deliver sales/marketing models. In one embodiment each app is developed from smaller buildings blocks.

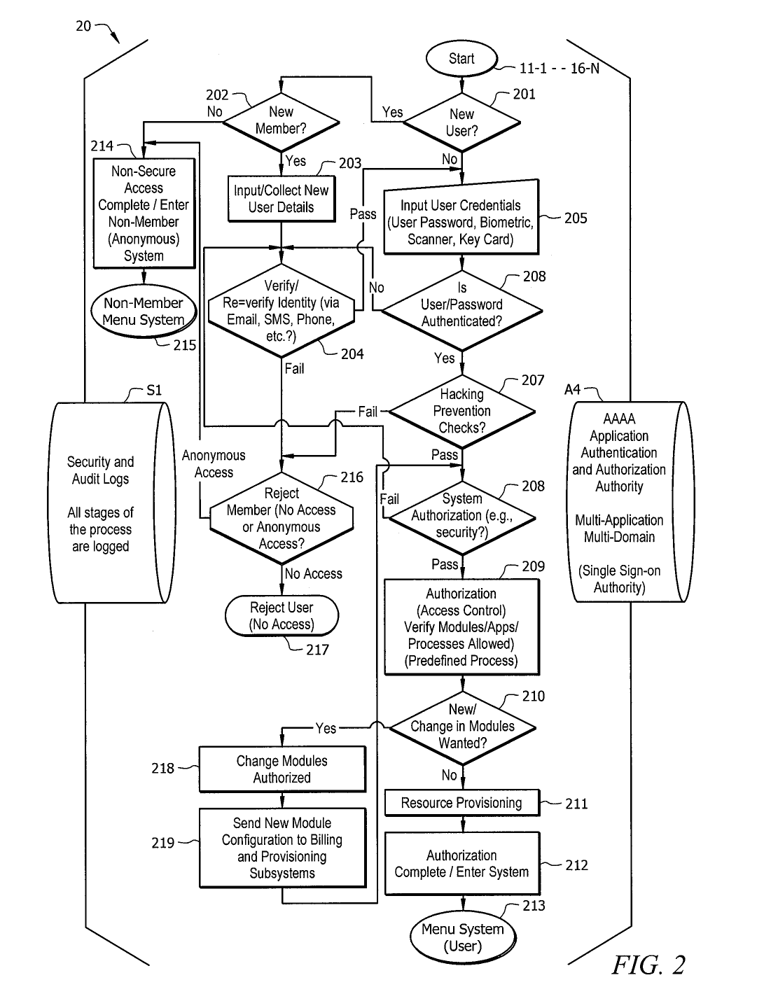

FIG. 2 shows one embodiment of a system including the concepts of the present invention illustrating one process for a login and/or registration process for a user (not a merchant/business). It includes various systems for checking identity, authentication, authorization and hacking. It also shows that the process (as with all processes in the system) is automatically overseen by a Security and Audit Logging subsystem and by an Application Authentication and Authorization Authority (A4) subsystem. The Security and Audit Logging subsystem performs the task of monitoring and logging for known threats and for transaction tracking. The A4 subsystem performs the task of single sign-on manager across all related sites and systems that would otherwise require a user to logon to each such site or system individually. FIG. 2 also shows the process for editing a user account and for accessing and controlling which system modules the user can access and use, including module provisioning. It should be noted that the term modules as used here are for system functions (e.g., the ability to do remote printing, access the accounting system and so forth). As used herein “applications” are more specifically for sales/marketing models.

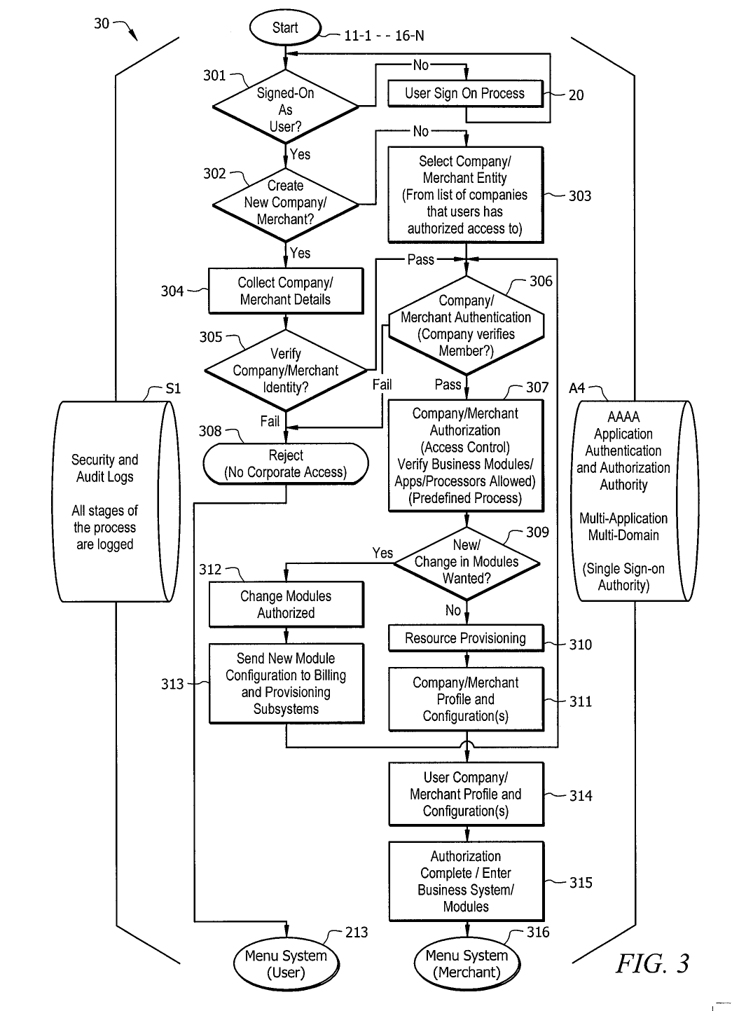

FIG. 3 shows one embodiment of a system including the concepts of the present invention illustrating one process for a login and/or registration process for a merchant. In the embodiment shown, a merchant must first be registered as a user of the system (only merchants can set/edit sales events/deals and/or set/edit sales/marketing models). Note that for the purpose of posting a new sales event or selecting a new sales/marketing model, a merchant can have one or numerous users but cannot have no users assigned to it. As with the User Login/Registration (FIG. 2), FIG. 3 also shows the process for editing a merchant account and for accessing and controlling which system modules the merchant can access and use, including module provisioning.

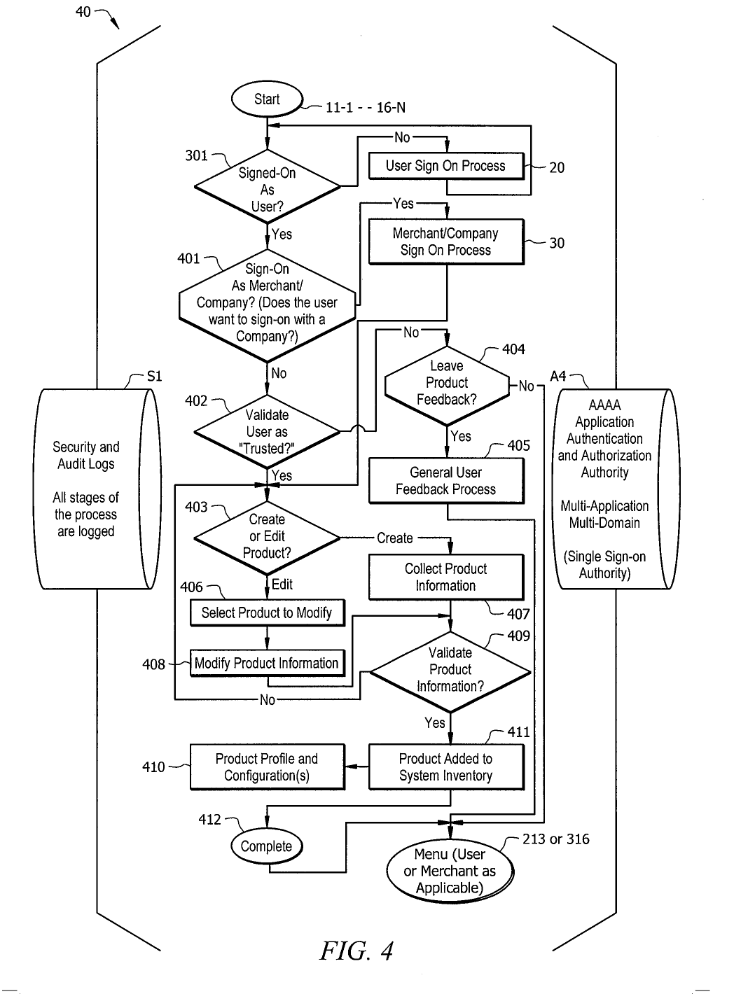

FIG. 4 shows one embodiment of a system including the concepts of the present invention illustrating one process for product input/editing for trusted users (e.g., merchants) including the ability for untrusted users to be limited to providing product Feedback.

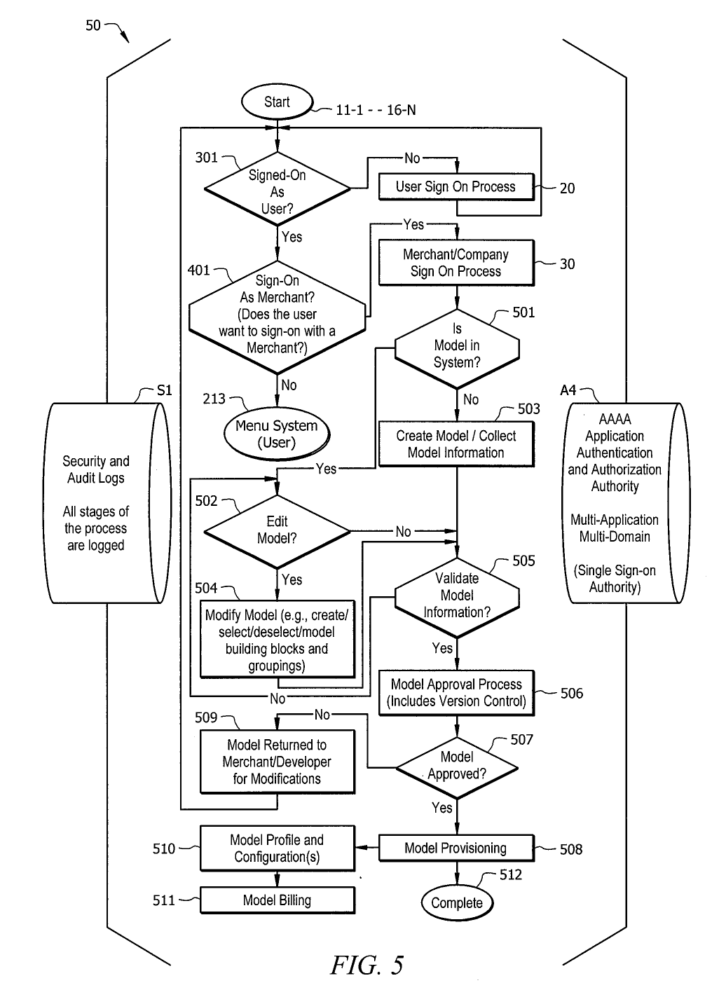

FIG. 5 shows one embodiment of a system including the concepts of the present invention illustrating one process for selecting/setting and/or editing a sales/marketing model (merchant only). Process 501 collects modeling information from the merchant and determines if that model is already in the system. If it is not, then process 503 gathers the parameters of the model from the merchant and perhaps provides the merchant with choices to select from. Processes 502 and 504 allow the merchant to modify existing models. Then the model, whether new or existing, is validated by processes 505, 506 and 507 to determine if the model is workable and to determine if all the rules of the model are in place. These rules pertain to the model type, (auction, penny auction, group discount, etc), the time (start and stop dates, time of day) number of items, geographic location (can be city wide, neighborhood wide, all people within a zip code, and/or within a GPS boundary, etc.). All of these rules are within the control of the merchant. The validation process allows complete flexibility within a wide set of pre-existing guidelines.

For example, the merchant may wish to sell 100 items at 40% off retail via a group discount model between the hours of 3 PM and 5 PM in a certain country only while at the same time offering the first 50 people to a certain web site to accept 50% off items from anywhere in the world. These are two different models and can run concurrently, if desired. The rules should provide for some payment to the host site and the method of calculating that amount could be varied. The guideline check could be set to accept or reject the payment plan, if desired.

Processes 508, 510 and 511 build the model using the rules provided by the merchant and, in most situations, the goods and/or services will be provided directly by the merchant and not by the host web site. Built into the modeling, if desired, is the ability to compare model results against different models or against desired results or against statistics of other models or other campaigns.

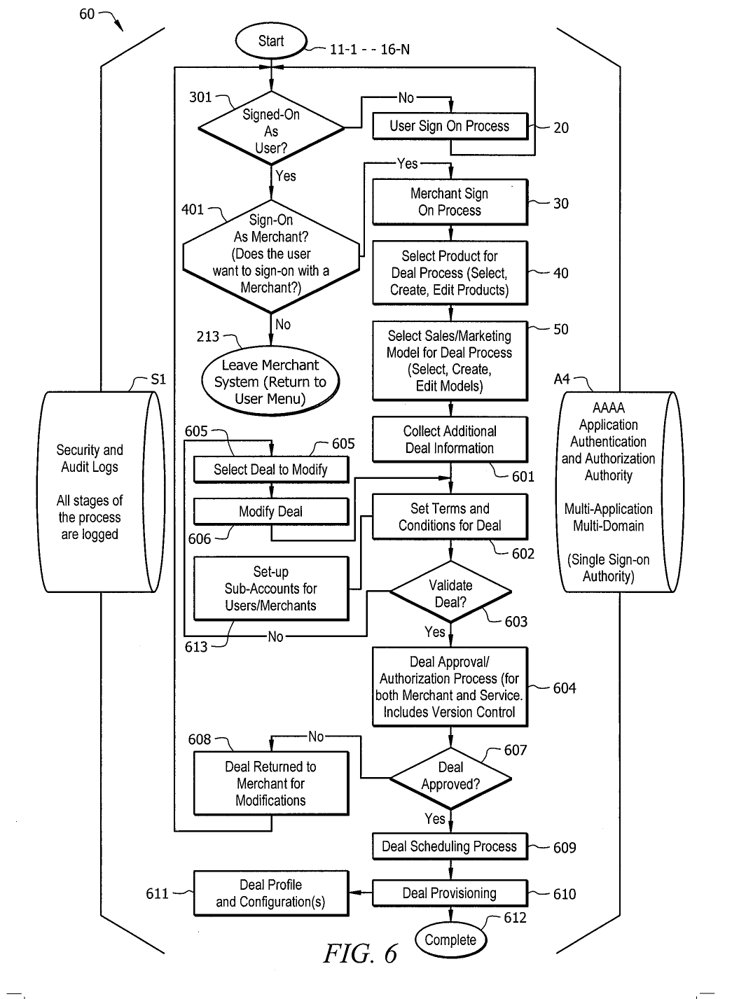

FIG. 6 shows one embodiment of a system including the concepts of the present invention illustrating one process for setting a sales event/deal (merchant only). Here the merchant also has the ability to set its own terms and schedule as to when their deal runs, if that information is not included in the rules set forth in the basic model. The merchant also has the ability, within the rules of each model, under control of process 613, to set up a payment system for users to take advantage of. The payment plan allows the merchant to set up sub-accounts of a master account and then to allow users to use “credit” in the sub-accounts to pay for goods or services.

Note that the actual presentation to potential users can be from a single website regardless of the model(s) desired by the merchant and/or from various specialized websites with the model rules coming from a single website.

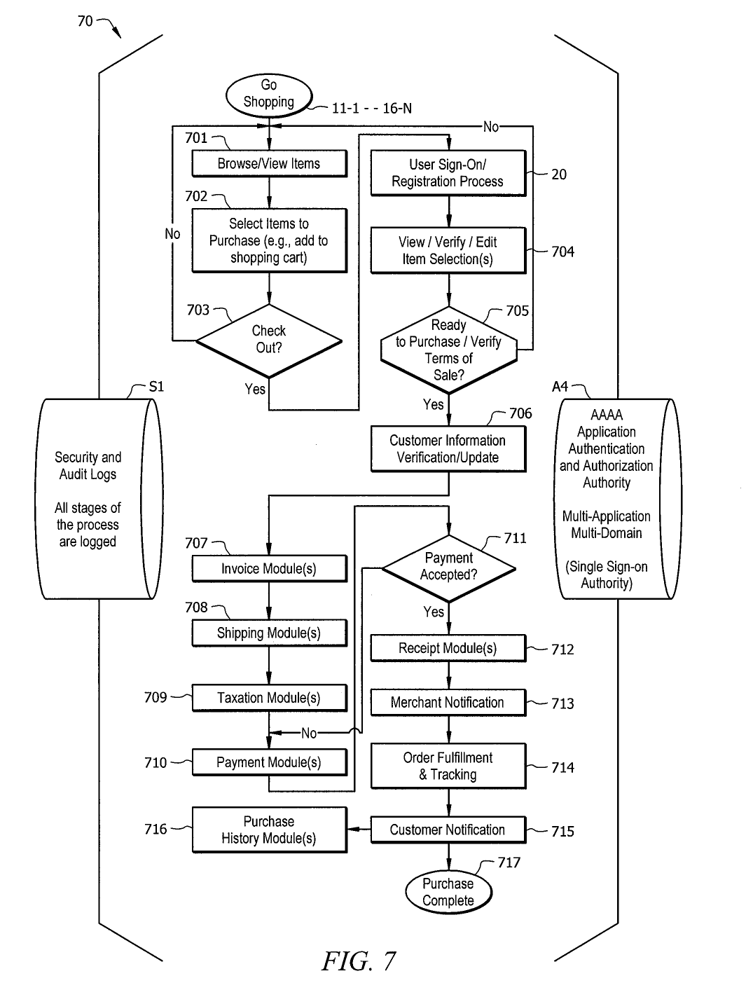

FIG. 7 shows one embodiment of a system including the concepts of the present invention illustrating one process for allowing a user to shop (browse for products and services), purchase the product and pay for the product.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for allowing a merchant to establish an on-line merchandising plan, said method comprising:
receiving at a server from a prospective merchant a set of rules pertaining to a desired marketing plan for selling goods/services;
determining by said server if received ones of said rules meet pre-established guidelines; and
implementing said receiving merchant rules on one or more on-line sites, providing said rules meet said filtering.

2. The method of claim 1 wherein said rules establish all parameters of said marketing plan, including time, audience, format, pricing.

3. The method of claim 2 providing each said merchant a sub-account of a main account so as to facilitate user payment of goods/services bought by said user.

4. A website for conducting e-commerce, said website comprising:
at least one server for accepting from merchants a set of rules for allowing said merchant to sell said merchant's goods/services to users browsing said website, accepted ones of said rules sets complying with a set of guidelines that all rule sets must be in compliance with; and
means operative upon accepting a particular rule set from a particular merchant for presenting said particular merchant's goods/services to said users in accordance with said particular rules.

5. The website in accordance with claim 4 wherein said rule sets comprise at least one of the following: type of sales model, type of marketing model, time of selling, cost of goods/services, location of potential users.

6. The website in accordance with claim 5 wherein said type of sales model is selected from: group discounts requiring pre-affiliation by a group of users, auction of goods/services over a period of time, penny auction, timed heavy discounts to a specific set of users, heavy discounts to a wide set of users for a short period, any other type of sales model constructed by a merchant within said guidelines.

7. The website in accordance with claim 4 wherein said guidelines are minimal in order to protect said website from abuse and wherein said guidelines are applied evenly to all merchant rule sets under processor control.

8. The website in accordance with claim 4 wherein a plurality of said rule sets are tested separately and tested against each other.
